(19) United States
(12) Patent Application Publication
(10) Pub. No.: US 2020/0408638 A1
(43) Pub. Date: Dec. 31, 2020

(54) TOP DRIVE MONITORING SYSTEM

(71) Applicant: FORUM US, INC., Houston, TX (US)

(72) Inventors: Chris HARSHBARGER, Cypress, TX (US); Shane RICHARD, Tomball, TX (US)

(21) Appl. No.: 16/453,641

(22) Filed: Jun. 26, 2019

(51) Int. Cl. G01M 13/02; G01M 13/04; G05B 23/02

(52) U.S. Cl. CPC G01M 13/02; G05B 23/0254; G01M 13/04

(57) ABSTRACT

A system for monitoring a component part of a top drive in real time comprises a top drive, one or more operating sensors coupled to the top drive, and an onboard processing transceiver coupled to the top drive and in communication with the operating sensors. The operating sensors are configured to measure operational data of the top drive during operation. The onboard processing transceiver is configured to determine a remaining life of the component part.

### BACKGROUND

### Field

Embodiments of this disclosure relate to systems and methods for monitoring top drive systems utilized in oil and gas drilling operations.

### Description of the Related Art

A top drive is a mechanical device on a drilling rig that provides clockwise torque to a drill string to drill a borehole. The top drive is connected to the drill string via a short section of pipe known as a quill that is located at a place below a traveling block that moves vertically up and down relative to the drilling rig. The top drive is considered the most critical system on the drilling rig, and when the top drive fails, the drilling operation is shut down.

In many cases failure of a top drive is due to failure of a relatively inexpensive component part within the top drive. These component parts are not typically monitored closely during operations. As such, the damaged component part continues to deteriorate which typically damages other component parts of the top drive. Thus, what could have been a relatively inexpensive repair to the one damaged component part turns into repair of multiple component parts of the top drive. This is time intensive as well as expensive.

Therefore there is a need for new and improved systems and methods for monitoring component parts of a top drive during oil and gas drilling operations.

### SUMMARY

In one embodiment, a system for monitoring a top dive in real time comprises a top drive having a component part; one or more operating sensors coupled to the top drive, wherein the operating sensors are configured to measure operational data of the top drive during operation; a processing transceiver coupled to the top drive and in communication with the operating sensors, wherein the onboard processing transceiver is configured to calculate performance data of the top drive; and a controller or cloud based system in communication with the processing transceiver and configured to predict failure of the component part based on the remaining life of the component part as calculated using the performance data.

In one embodiment, a method for monitoring a component part of a top drive in real time comprises receiving operational data from one or more operating sensors that are coupled to the top drive; calculating stress data based on the operational data; calculating fatigue data and/or cumulative damage data based on the stress data, wherein the stress data and the fatigue data and/or cumulative damage data are calculated by a processing transceiver coupled to the top drive, wherein the operational data, the stress data, and the fatigue data and/or cumulative damage data are output in the form of performance data; transmitting the performance data to a controller or cloud based system; and predicting failure of the component part based on a remaining life of the component part as calculated using the performance data via the controller or cloud based system.

### BRIEF DESCRIPTION OF THE DRAWINGS

So that the manner in which the above-recited features of the disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic diagram of one embodiment of a real-time performance monitoring and predictive maintenance system for determining structural health of a piece of equipment in real time.

FIG. 2 illustrates a top drive system, which is one embodiment of the piece of equipment as described in FIG. 1.

FIGS. 3A and 3B illustrate a top drive according to one embodiment that may be used with the top drive system of FIG. 2.

FIG. 4 is a flow chart depicting one embodiment of a method utilizing the real-time performance monitoring and predictive maintenance system of FIG. 1.

FIG. 5 is a graph representing remaining life of a component part of a piece of equipment over time.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments disclosed herein relate to a real-time monitoring system configured to monitor a piece of equipment used in the oil and gas industry. The real-time monitoring system includes one or more operating sensors configured to monitor the operating conditions of the piece of equipment in real time. The piece of equipment includes the entire piece equipment, a portion of the equipment, or a component part of the equipment. The real-time monitoring system as described herein includes a performance monitoring and predictive maintenance system configured to monitor conditions of the piece of equipment. The real-time monitoring system as described herein may be utilized for optimizing maintenance intervals of the piece of equipment as well as notify an operator of the same. The real-time monitoring system as described herein may also predict the lifetime of the piece of equipment, predict failure of the piece of equipment (e.g. the entire piece of equipment, a portion of the equipment, or a component part of the equipment), as well as notify an operator of the same.

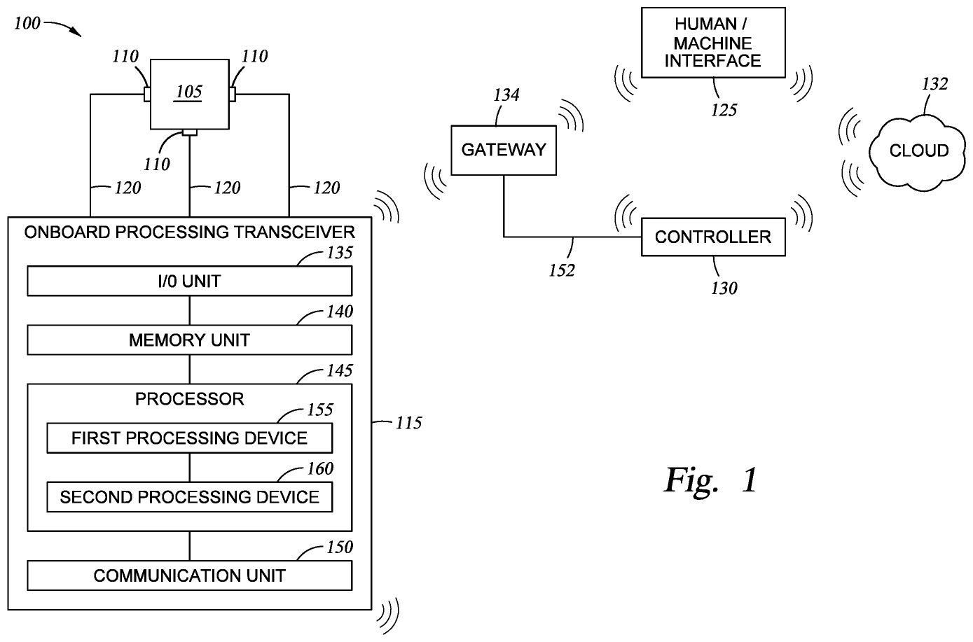

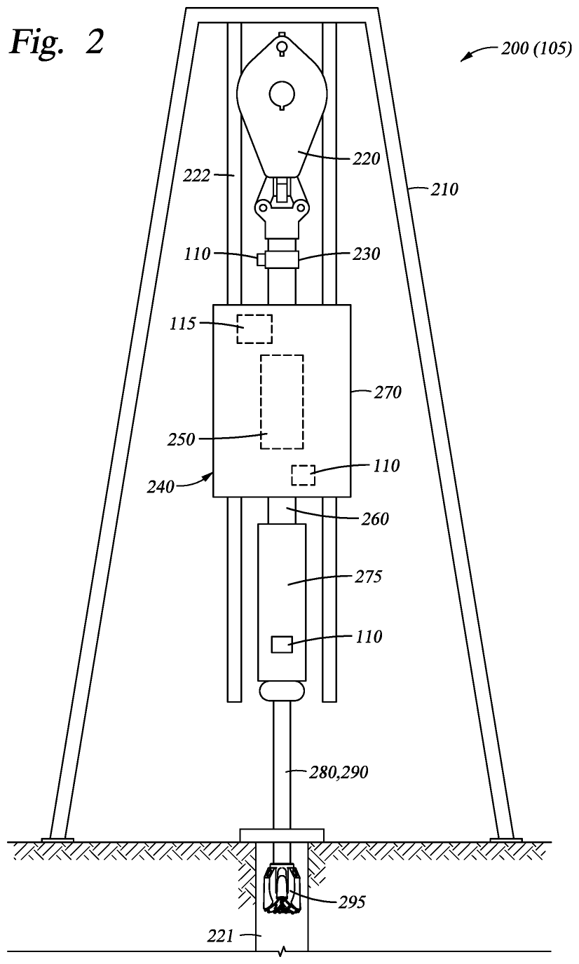

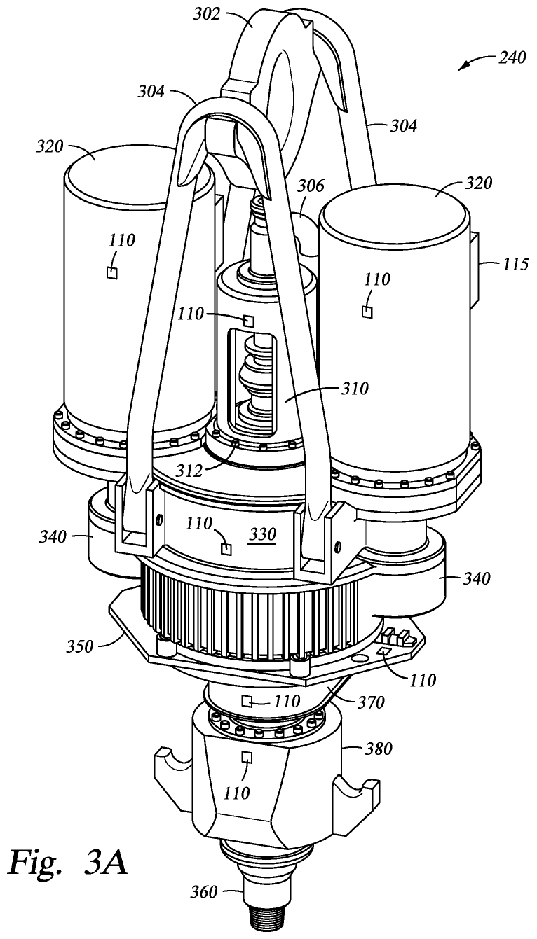

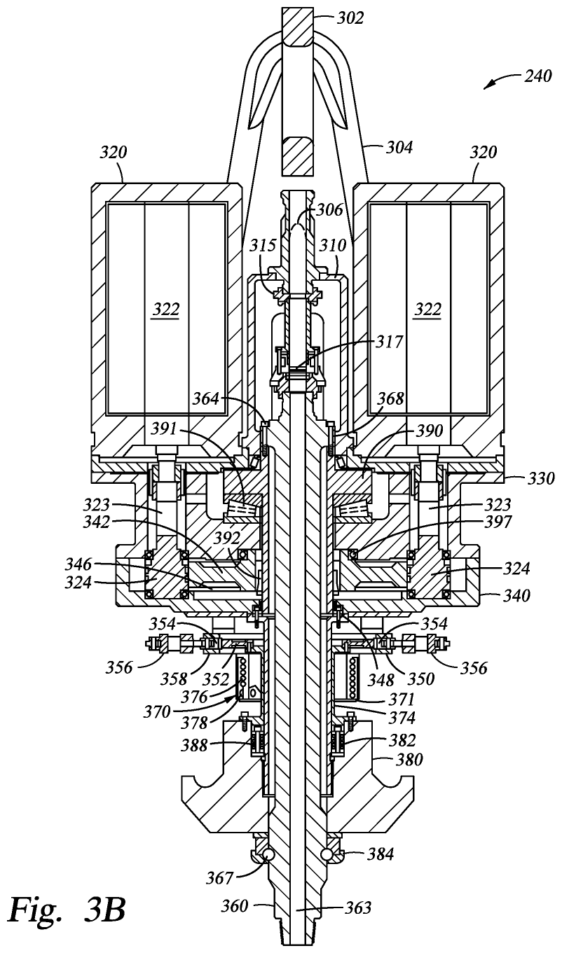

FIG. 1 is a schematic diagram of one embodiment of a real-time monitoring system 100 configured to monitor conditions of a piece of equipment 105, including but not limited to, the entire piece of equipment 105, one or more portions of the equipment 105, and/or one or more component parts in or on the piece of equipment 105. The piece of equipment 105 may be a top drive system as described in FIGS. 2, 3A and 3B. One or more operating sensors 110 are coupled to the piece of equipment 105. The component parts may be bearings, motors and other power systems, hydraulic systems, as well as other component parts of the piece of equipment 105.

The operating sensors 110 are configured to gather operational data relating to the operation of the piece of equipment 105. The operational data includes location of the operating sensors 110, vibration data, loading conditions, and/or boundary conditions. Location of the operating sensors 110 is utilized to determine the component part being monitored. Loading conditions include, but are not limited to, load, weight, stress, pressure, vibration, temperature, speed, current, and/or voltage. Boundary conditions include, but are not limited to, orientation data, position data, and/or angle data.

The operational data gathered by the operating sensors 110 is communicated to an onboard processing transceiver 115 via a connection 120. The connection 120 may be wired or wireless. The onboard processing transceiver 115 is coupled (directly or indirectly) to the piece of equipment 105, and is dedicated to the piece of equipment 105 such that the onboard processing transceiver 115 travels with the piece of equipment 105 from one location to the next. The onboard processing transceiver 115 may be paired with the piece of equipment 105 for the operational lifetime of the piece of equipment 105.

The operational data transmitted to the onboard processing transceiver 115 from the operating sensors 110 via the connection 120 may be at a first frequency, such as about 60,000 data points per second. The operational data is processed by the onboard processing transceiver 115 to calculate stress and fatigue and/or cumulative damage as further described below. The onboard processing transceiver 115 is configured to transmit the operational data, the stress, and the fatigue and/or cumulative damage in the form of performance data to a human/machine interface 125, a controller 130, and/or a cloud based system 132 via a gateway 134 at a second frequency, such as about 120 data points per second, that is lower than the first frequency. The human/machine interface 125 and/or the controller 130 may be positioned at a location remote from the piece of equipment 105.

The onboard processing transceiver 115 includes an input/output unit 135, a memory unit 140, a processor 145, and a communication unit 150. The input/output unit 135 is configured to receive and/or retrieve the operational data from the operating sensors 110. The operational data can be stored in the memory unit 140 and communicated to the processor 145, which is configured to calculate the stress and fatigue and/or cumulative damage based on the operational data. The operational data, the stress, and the fatigue and/or cumulative damage can be stored in the memory unit 140, and communicated to the human/machine interface 125, the controller 130, and/or the cloud based system 132 wirelessly via the communication unit 150 and the gateway 134. The gateway 134 may be connected to the controller 130 via a wired connection 152.

The processor 145 includes a first processing device 155 and a second processing device 160. Each of the first processing device 155 and the second processing device 160 may include software containing an algorithm configured to perform the calculations described herein.

The first processing device 155 calculates stress of the piece of equipment 105 based on the operational data (such as loading conditions and boundary conditions) and outputs stress data. The stress data is communicated to the second processing device 160. The second processing device 160 calculates fatigue and/or cumulative damage of the piece of equipment 105 based on the stress data (such as by comparing a stress range over time) and outputs fatigue data and/or cumulative damage data. The operational data, the stress, and the fatigue data and/or cumulative damage data is communicated in the form of performance data to the controller 130 and/or the cloud based system 132 via the gateway 134.

The controller 130 and/or the cloud based system 132 is configured to identify the piece of equipment 105, such as the component part of the equipment 105, being monitored based on the performance data (e.g. the operational data received from the operating sensors 110) transmitted via the gateway 134. The controller 130 and/or the cloud based system 132 also contains a life prediction model that calculates the remaining life of one or more component parts based on a comparison with a system model, and therefore can predict failure of the one or more component parts. The controller 130 and/or the cloud based system 132 is configured to select a system model to use based on the performance data and/or the component part. The system model includes performance data based on normal operation of a piece of equipment that is similar to the piece of equipment 105.

For example, if the performance data from the operating sensors 110 includes data related to vibration, and the component part identified by the controller 130 and/or the cloud based system 132 is a valve, then the controller 130 and/or the cloud based system 132 will select a system model that includes data relating to vibration experienced by the same piece of equipment and/or component part during normal operation. Normal operation includes initial operation of the piece of equipment and/or operation of the piece of equipment after repair and/or maintenance. Multiple system models (e.g. that includes performance data relating to vibration) are preprogrammed into the controller 130 and/or the cloud based system 132.

The controller 130 and/or the cloud based system 132 compares the performance data with one or more system models to calculate the remaining life of the component part. For example, the controller 130 and/or the cloud based system 132 calculates remaining life of the component part of the piece of equipment 105 by comparing the fatigue data and/or cumulative damage data calculated by the onboard processing transceiver 115 to a system model having fatigue data and/or cumulative damage data based on traditional stress models. The controller 130 and/or the cloud based system 132 outputs the performance data, the component part identified, the system model, and/or the calculated remaining life of the component part in the form of working data to the human/machine interface 125. In response, one or a combination of the human/machine interface 125, the controller 130, and/or the cloud based system 132 may be configured to control the operation of the piece of equipment 105 based on the working data.

The human/machine interface 125 can be a display device where an operator can view the working data. The display device may be a personal computer, a screen coupled to the piece of equipment 105, and/or a cellular phone. The controller 130 can be a control device having a central processing unit and/or any other control mechanisms configured to receive and process the performance data, the component part identified, the system model, and/or the calculated remaining life of the component part, as well as control the operation of the piece of equipment 105. The cloud based system 132 can be a remote server accessible via the internet similarly configured to receive and process the performance data, the component part identified, the system model, and/or the calculated remaining life of the component part, as well as control the operation of the piece of equipment 105.

The human/machine interface 125, the controller 130, and/or the cloud based system 132 are configured to communicate with each other via wired and/or wireless communication to control the operation of the piece of equipment 105 based at least in part on the working data.

In one example, an operator can view the performance data, the component part identified, the system model, and/or the calculated remaining life of the component part on the human/machine interface 125 (as received and/or retrieved from the onboard processing transceiver 115, the controller 130, and/or the cloud based system 132) and then in response instruct the controller 130 to start, stop, and/or adjust the operation of the piece of equipment 105.

In one example, the controller 130 can automatically start, stop, and/or adjust the operation of the piece of equipment 105 based at least in part on the performance data, the component part identified, the system model, and/or the calculated remaining life of the component part on the human/machine interface 125 (as received and/or retrieved from the onboard processing transceiver 115, the controller 130, and/or the cloud based system 132) and then in response inform the operator via the human/machine interface 125.

In one example, the cloud based system 132 can automatically start, stop, and/or adjust the operation of the piece of equipment 105 (directly or via the controller 130) based at least in part on the performance data, the component part identified, the system model, and/or the calculated remaining life of the component part (as received and/or retrieved from the onboard processing transceiver 115, the controller 130, and/or the cloud based system 132) and then in response inform the operator via the human/machine interface 125.

The human/machine interface 125, the controller 130, and/or the cloud based system 132 are configured to calculate and/or log the operational history of the piece of equipment 105 based on the working data. The operational history can be obtained directly from one or more of the operating sensors 110, which data is passed through the onboard processing transceiver 115 as part of the performance data for processing and/or logging by the human/machine interface 125, the controller 130, and/or the cloud based system 132. The operational history includes at least one of information on cycles of the equipment and operational hours of the equipment.

The operational data is communicated on a continuous or as-needed basis to the onboard processing transceiver 115 in real time or near real time such that the working data, e.g. the performance data, the component part identified by the controller 130 and/or the cloud based system 132, the calculated remaining life of the component part, and/or any other operational data of the piece of equipment 105 or the component part is known on a real time basis. Based on the working data, the real-time monitoring system 100 can predict the remaining life of the component part, and therefore can predict failure of the one or more component parts as well as the remaining operating life of the piece of equipment 105, identify operating trends, as well as optimal service intervals to optimize the operating life of the equipment 105.

FIG. 2 illustrates a top drive system 200 according to the present disclosure which is one embodiment of a piece of equipment 105 as described in FIG. 1. The top drive system 200 is structurally supported by a derrick 210. The system 200 has a plurality of components including a swivel 230, a top drive 240, a main shaft 260, a motor housing 270, an adapter 275, a drill stem 280/drill string 290, and a drill bit 295. The components are collectively suspended from a traveling block 220 that moves them upwardly and downwardly on rails 222 connected to the derrick 210. The main shaft 260 extends through the motor housing 270 and connects to the drill stem 280 via the adapter 275. The drill stem 280 is typically threadedly connected to one end of a series of tubular members collectively referred to as the drill string 290. An opposite end of the drill string 290 is threadedly connected to the drill bit 295. Torque generated during operations with the top drive 200 or its components (e.g. during drilling) is transmitted to the drill stem 280/drill string 290/drill bit 295.

The top drive system 200 includes a plurality of operating sensors 110 coupled to the top drive 240. Each of the operating sensors 110 are in communication with the onboard processing transceiver 115 to transmit operational data as described above. For example, the operational data of the top drive system 200 as measured by the operating sensors 110 is communicated to the onboard processing transceiver 115 via wired or wireless communication to calculate the performance data as described herein and transmit the performance data to the human/machine interface 125, the controller 130, and/or the cloud based system 132 (all shown in FIG. 1), which then calculates the remaining life of one or more component parts of the top drive system 200.

During operation, a motor assembly 250 encased within the motor housing 270 rotates the main shaft 260 which, in turn, rotates the drill stem 280/drill string 290/drill bit 295 via the adapter 275. Rotation of the drill bit 295 produces a bore hole 221. Fluid pumped through the top drive 200 passes through the main shaft 260, the adapter 275, the drill stem 280, the drill string 290, the drill bit 295, into the bore hole 221. Cuttings removed by the drill bit 295 are cleared from the bore hole 221 as the pumped fluid passes out of the bore hole 221 up through an annulus formed between the outer surface of the drill bit 295 and the walls of the bore hole 221.

FIGS. 3A and 3B illustrate a top drive 240 according to one embodiment that may be used with the top drive system 200 of FIG. 2. The top drive 240 has a pair of supporting bails 304 suspended from a becket 302. A pair of motors 320 (e.g., the motor assembly 250 of FIG. 2) which rotate a main shaft 360 are supported on a main body 330. A bonnet 310 supports a gooseneck 306 and a wash pipe through which fluid is pumped to and through the top drive 240 and through a flow channel 363 in the main shaft 360. Within the bonnet 310 are an upper packing box 315, which is connected to the gooseneck 306, and a lower packing box 317.

A main gear housing 340 encloses a bull gear 342 and other associated components as described in detail below. A ring gear housing 350 encloses a ring gear 352 and associated components as described in detail below.

Shafts 322 of the motors 320 rotate coupling members 323 rotatably mounted in the main body 330, which rotates drive pinions 324 in the main gear housing 340. The drive pinions 324 drive the bull gear 342 which is coupled to a quill 390 with connectors 392. The motors 320 drive the quill 390 and thus the main shaft 360 which is connected to the quill 390. Radial bearings 397 support the bull gear 342.

The bull gear 342 is within a lower portion 346 of the gear housing 340 which holds lubricant for the bull gear 342 and is sealed with a seal apparatus 348 so that the lubricant does not flow out and down from the gear housing 340. Any suitable known rotary seal may be used as the seal apparatus 348. Within the gear housing 340, the bull gear 342 and the drive pinions 324 sit in lubricating oil, eliminating the need for spray nozzles, distribution pumps, and flow or pressure sensors employed in various prior systems.

The ring gear housing 350 which houses the ring gear 352 also has movably mounted therein two sector gears 354 each movable by a corresponding hydraulic cylinder apparatus 356 to lock the ring gear 352. With the ring gear 352 unlocked (with the sector gears 354 backed off from engagement with the ring gear 352), items below the ring gear housing 350 (e.g. a pipe handler on the link adapter) can rotate. The ring gear 352 can be locked by the sector gears 354 to act as a backup to react torque while drill pipe connections are being made to the drill string.

The ring gear 352 is locked when a pipe handler is held without rotation (e.g. when making a connection of a drill pipe joint to a drill string). A hydraulic motor 358, via a gear, turns the ring gear 352 to rotate the link adapter 380 and whatever is suspended from it, such as in certain aspects to permit the movement of a supported tubular to and from a storage area and/or to change the orientation of a suspended elevator so that the elevator's opening throat is facing in a desired direction. Typical rig control systems are used to control the motor 358 and the cylinder apparatus 356 and typical rig power systems provide power for them.

A drag chain system 370 encloses a drag chain 376 and associated components including hoses and cables as described below. The drag chain system 370 eliminates the need for a rotating head used in several prior systems and provides sufficient rotation for reorientation of a link adapter 380 and items connected thereto. The drag chain system 370 includes a rotatable spool 374 which is rotated by the chain 376. In one position the chain 376 is wound around the periphery of the spool 374. As the chain 376 unwinds from the spool 374 as the spool 374 is rotated by the hydraulic motor 358 rotating the ring gear 352, the unwinding chain portion feeds into a housing 371 in which it resides until the spool 374 is rotated in the opposite direction and the chain 376 is again wound onto the spool 374. As the chain 376 winds and unwinds, hoses and cables 378 wind and unwind with the chain 376.

Springs 388 within a spring cartridge 382 push upwardly on the spool 374, lifting the spool 374 between the link adapter 380 and a load ring 384, which is secured to the main shaft with a split ring 367, so that during drilling for example, the main shaft 360 can rotate independently of the link adapter 380 and whatever is connected thereto. The springs 388 can support the weight of the link adapter 380, as well as any links, bails, or elevator apparatus connected to the link adapter 380.

When tubular(s) are engaged by the elevator apparatus, the springs 388 collapse as shown in FIG. 3B, the link adapter 380 moves down to rest on the load ring 384, the load then passes to and through the main shaft 360. Thus, the link adapter 380 (and whatever is connected thereto) can be maintained stationary while drilling. When a sufficient load is placed on the link adapter 380 (e.g. when hoisting the drill string with an elevator or running casing), the forces of the springs 388 are overcome, the link adapter 380 is moved down to rest on the load ring 384 so that the link adapter load is transferred to the load ring 384.

Bolts 312 releasably secure the bonnet 310 to the body 330. Removal of the bolts 312 permits removal of the bonnet 310. Bolts 364 through a load shoulder 368 releasably secure the main shaft 360 to the quill 390. The quill 390 is a transfer member between the main shaft 360 and the bull gear 342 by transferring torque between the bull gear 342 and the main shaft 360. The quill 390 also transfers the tension of a tubular or string load on the main shaft to main thrust bearings 391 (not to the bull gear 342).

The quill 390 rests on the main thrust bearings 391 which support the quill 390, the main shaft 360, and whatever is connected to the main shaft 360 (including whatever load is on the main shaft 360 during operations, e.g. drilling loads and tripping loads). The body 330 houses the main thrust bearings 391 and contains lubricant for the main thrust bearings 391.

As shown in FIG. 3A, the operating sensors 110 are shown coupled to the bonnet 310, the link adapter 380, the drag chain system 370, the ring gear housing 350, the motors 320, and the main body 330. The operating sensors 110 are configured to measure the operating conditions of the top drive 240 to gather operational data. The operating sensors 110 are configured to transmit the operational data to the onboard processing transceiver 115 for processing as described herein.

In one example, the operating sensors 110 are configured to measure vibration of the top drive 240 (such as by measuring the movement of the various components using one or more accelerometers) during operation. In one example, the operating sensors 110 are configured to measure the position of the top drive 240 using an angle encoder or a proximity sensor during operation. In one example, the operating sensors 110 are configured to determine the position of the motors 320 by measuring the angle of the main shaft 360.

In one example, the operating sensors 110 are configured to measure vibration of the components of the top drive 240, such as by measuring velocities of the top drive 240 components during operation. The vibration may be isolated near the bonnet 310, the link adapter 380, the drag chain system 370, the ring gear housing 350, the motors 320 and the main body 330. In one example, the operating sensors 110 are configured to measure pressure(s) of the hydraulic cylinder apparatus 356 and/or the hydraulic motor 358.

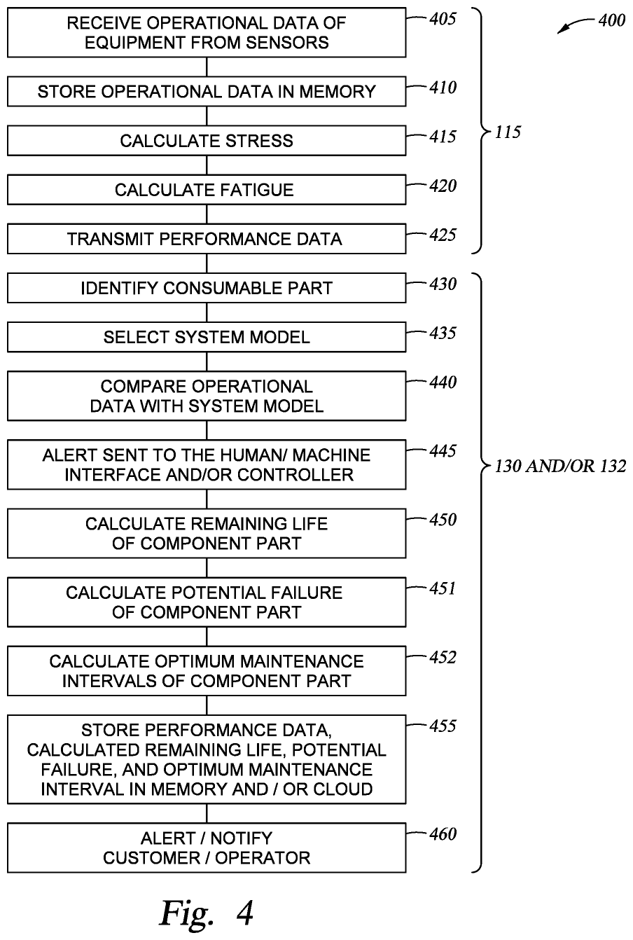

FIG. 4 is a flow chart depicting one embodiment of a method 400 utilizing the real-time monitoring system 100 of FIG. 1. The method 400 is utilized to determine the remaining life of a piece of equipment, including but not limited to, the entire piece of equipment, a portion of the equipment, and/or one or more component parts of the equipment. The remaining life can be used to predict failure of the equipment and/or one or more component parts in or on the piece of equipment, such as the piece of equipment 105 of FIG. 1, and/or the top drive 240 of FIGS. 2, 3A and 3B.

At step 405, the onboard processing transceiver 115 receives operational data of the piece of equipment from the operating sensors 110. The operational data includes location of the operating sensors 110, loading conditions, and/or boundary conditions. Loading conditions include, but is not limited to, load, weight, stress, pressure, vibration, temperature, speed, current, and/or voltage. Boundary conditions include, but are not limited to, orientation data, position data, and/or angle data. Vibration from the locating conditions includes vibrational frequencies measured by accelerometers or other types of vibration sensors. The operating sensors 110 measure and communicate the operational data regarding the component part and the piece of equipment in real time and continuously to the input/output unit 135 of the onboard processing transceiver 115 during operation of the piece of equipment.

Optionally, at step 410, the operational data may be stored on the memory unit 140 of the onboard processing transceiver 115.

At step 415, the first processing device 155 of the processor 145 of the onboard processing transceiver 115 calculates stress of the piece of equipment 105 based on the operational data (such as loading conditions and boundary conditions) and outputs stress data. The stress data is communicated to the second processing device 160.

At step 420, the second processing device 160 the processor 145 of the onboard processing transceiver 115 calculates fatigue and/or cumulative damage of the piece of equipment 105 based on the stress data (such as by comparing a stress range over time) and outputs fatigue data and/or cumulative damage data.

At step 425, the communication unit 150 of the onboard processing transceiver 115 transmits the operational data, the stress data, and the fatigue data and/or cumulative damage data in the form of performance data to the controller 130 and/or the cloud based system 132 via the gateway 134. The performance data can be communicated to the human/machine interface 125 via wireless communication at a frequency lower than the frequency that the operational data was communicated to the onboard processing transceiver 115.

At step 430, the controller 130 and/or the cloud based system 132 identifies the component part being monitored based on the performance data (e.g. the operational data received from the operating sensors 110 and/or the stress and fatigue and/or cumulative damage data as calculated by the onboard processing transceiver 115). For example, the motors 320 shown in FIGS. 3A and 3B may be identified as the component part based on performance data in the form of operating hours and/or power output.

At step 435, the controller 130 and/or the cloud based system 132 selects a system model to use based on the performance data and/or the component part identified at step 430. For example, the system model for a motor, similar to the motors 320 shown in FIGS. 3A and 3B, may be selected based on the performance data and/or the identification in step 430.

At step 440, the controller 130 and/or the cloud based system 132 compares the performance data of the component part with the system model. For example, the controller 130 and/or the cloud based system 132 compares the system model of a motor (which may include performance data of a similar motor operating under normal operating conditions and according to a predefined schedule) with the actual performance data of the motors 320 (shown in FIGS. 3A and 3B) as gathered by the operating sensors 110.

Optionally, at step 445, an alert is sent to the human/machine interface 125 and/or the controller 130 if component part failure is detected or imminent based on the system model comparison.

At step 450, based on the comparison of the performance data with the system model, the controller 130 and/or the cloud based system 132 calculates the remaining life of the component part. For example, the remaining life of the motors 320 shown in FIGS. 3A and 3B may be calculated.

At step 451, the controller 130 and/or the cloud based system 132 calculates a potential failure of the component part. For example, the potential failure of the motors 320 shown in FIGS. 3A and 3B may be calculated.

At step 452, the controller 130 and/or the cloud based system 132 calculates optimum maintenance intervals of the component part. For example, the optimum maintenance interval(s) of the motors 320 shown in FIGS. 3A and 3B may be calculated.

Optionally, at step 455, the performance data, the remaining life, the potential failure, and/or the optimum maintenance interval may be stored on a memory unit of the controller 130 and/or the cloud based system 132. Alternatively, or additionally, the performance data, the remaining life, the potential failure, and/or the optimum maintenance interval may be transmitted and stored in the cloud based system 132.

At step 460, the human/machine interface 125, the controller 130, and/or the cloud based system 132 are configured to alert/notify the operator with the performance data, the remaining life, the potential failure, and/or the optimum maintenance interval, as well as the operational history of the component part and/or the piece of equipment.

One or a combination of the human/machine interface 125, the controller 130, and/or the cloud based system 132 are also configured to identify trends within the performance data, the remaining life, and/or the potential failure to predict optimal maintenance intervals. The cloud based system 132 may be used to gather operational history from one or more component parts of a single piece of equipment or from several pieces of equipment (e.g. an entire fleet of equipment), and compare the operational histories of all the pieces of equipment to identify trends and help predict optimal maintenance intervals.

The onboard processing transceiver 115 is configured to gather the operational data as measured by the operating sensors 110, calculate the stress data and the fatigue data and/or cumulative damage data, and communicate the operational data, the stress data and the fatigue data and/or cumulative damage data in the form of performance data to the human/machine interface 125, the controller 130, and/or the cloud based system 132. The human/machine interface 125, the controller 130, and/or the cloud based system 132 are then configured to identify the component part associated with the performance data, select a system model (e.g. based on normal operation of the component part and/or piece of equipment), compare the performance data to the selected system model, and calculate the remaining life, the potential failure, and/or the optimum maintenance interval of each respective component part. The real-time monitoring system 100 may provide an indication of a shortened remaining life of the respective component parts during the operation of the piece of equipment and therefore predict failure of the component parts.

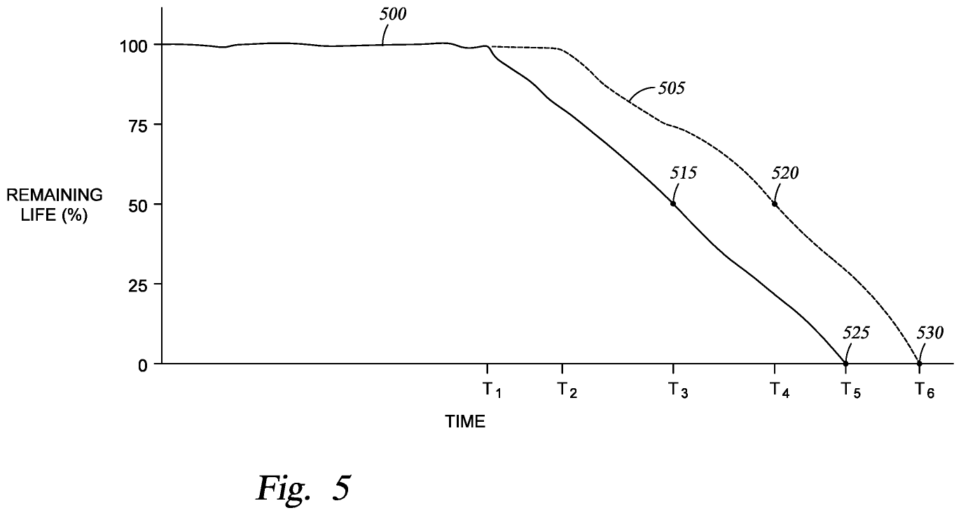

FIG. 5 is a graph representing percentage of remaining life of a component part over time. The component part may be a bearing, a motor, a gearbox, a seal, oil quality/life, a power system, and a hydraulic system, among others. Line 500 shows the scheduled remaining life of the component part operating at 100% under normal operating conditions until time T1 where efficiency of the component part drops. The scheduled remaining life as indicted by line 500 may be preprogrammed into the controller 130 and/or the cloud based system 132 as a system model. Line 505 represents the actual remaining life of the component part as measured by the real-time monitoring system 100. The actual remaining life as indicated by line 505 is calculated by the controller 130 and/or the cloud based system 132 based on the performance data retrieved and/or received from the onboard processing transceiver 115 according to embodiments described herein.

As shown, the actual remaining life of the component part does not begin to decline until time T2, which allows an operator to schedule maintenance and/or replacement operations at a later time more optimal time.

For one example, a scheduled maintenance at point 515 may be performed at time T3, which is 50% of the scheduled remaining life of the component part indicated by line 500 under normal operating conditions. However, as shown in FIG. 5, at time T3, the actual and/or predicted remaining life of the component part indicted by line 505 is about 75%. An operator may delay the maintenance time until the more optimal time T4, which is when the actual and/or predicted remaining life of the component part is 50%.

For another example, a scheduled replacement at point 525 may be performed at time T5, which is when the schedule remaining life of the component part indicated by line 500 should be at or near 0% under normal operating conditions. However, as shown in FIG. 5, at time T5, the actual and/or predicted remaining life of the component part indicted by line 505 is about 25%. An operator may delay replacement of the component part until the more optimal time T6, which is when the actual and/or predicted remaining life of the component part is at or near 0%.

Based on the above, if the scheduled remaining life of the component part under normal operating conditions is represented by line 500, and the actual and/or predicted remaining life as calculated by the real-time monitoring system 100 is represented by line 505, then an operator can schedule maintenance and/or replacement operations at a later time (or alternatively at an earlier time), thereby avoiding unnecessary (or needed) maintenance or replacement, as well as potential equipment failure and unexpected downtime.

While the foregoing is directed to embodiments of the disclosure, other and further embodiments may be devised without departing from the basic scope thereof, and the scope thereof is determined by the claims that follow.

1. A system for monitoring a top dive in real time, comprising:
a top drive having a component part;
one or more operating sensors coupled to the top drive, wherein the operating sensors are configured to measure operational data of the top drive during operation;
a processing transceiver coupled to the top drive and in communication with the operating sensors, wherein the onboard processing transceiver is configured to calculate performance data of the top drive; and
a controller or cloud based system in communication with the processing transceiver and configured to predict failure of the component part based on the remaining life of the component part as calculated using the performance data.

2. The system of claim 1, wherein the processing transceiver comprises a first processing device configured to calculate stress data based on the operational data.

3. The system of claim 2, wherein the processing transceiver comprises a second processing device configured to calculate fatigue data and/or cumulative damage data based on the stress data.

4. The system of claim 3, wherein the controller or cloud based system are configured to calculate the remaining life of the component part based the fatigue data and/or cumulative damage data.

5. The system of claim 1, wherein the processing transceiver is configured to receive the operational data at a first frequency, process the operational data to calculate performance data, and transmit the performance data at a second frequency that is lower than the first frequency.

6. The system of claim 5, wherein the processing transceiver is configured to transmit the performance data at the second frequency to a human/machine interface, or the controller or cloud based system.

7. The system of claim 1, wherein the remaining life is output in the form of a graph indicating percentage of remaining life over time.

8. The system of claim 1, wherein the operating sensors are wired to the processing transceiver.

9. The system of claim 1, wherein the operational data includes operational history, loading conditions, and boundary conditions, wherein the operational history includes at least one of information on cycles of the equipment and operational hours of the equipment, wherein the loading conditions includes at least one of load, weight, stress, pressure, vibration, temperature, speed current, and voltage, and wherein the boundary conditions include at least one of orientation data, position data, and angle data.

10. The system of claim 1, wherein the processing transceiver is dedicated to the top drive such that the processing transceiver travels with the top drive.

11. A method for monitoring a component part of a top drive in real time, comprising:
receiving operational data from one or more operating sensors that are coupled to the top drive;
calculating stress data based on the operational data;
calculating fatigue data and/or cumulative damage data based on the stress data, wherein the stress data and the fatigue data and/or cumulative damage data are calculated by a processing transceiver coupled to the top drive, wherein the operational data, the stress data, and the fatigue data and/or cumulative damage data are output in the form of performance data;
transmitting the performance data to a controller or cloud based system; and
predicting failure of the component part based on a remaining life of the component part as calculated using the performance data via the controller or cloud based system.

12. The method of claim 11, wherein the operational data includes operational history, loading conditions, and boundary conditions.

13. The method of claim 12, wherein the operational history includes at least one of information on cycles of the equipment and operational hours of the equipment.

14. The method of claim 12, wherein the loading conditions include at least one of load, weight, stress, pressure, vibration, temperature, speed, current, and voltage.

15. The method of claim 12, wherein the boundary conditions include at least one of orientation data, position data, and angle data.

16. The method of claim 11, further comprising transmitting the performance data and the remaining life a human/machine interface.

17. The method of claim 11, further comprising identifying the component part based on the performance data via the controller or cloud based system.

18. The method of claim 11, further comprising selecting a system model based on the performance data and comparing the performance data to the system model to calculate the remaining life of the component part.

19. The method of claim 11, further comprising controlling the operation of the top drive based on the performance data or the remaining life of the component part.

20. The method of claim 11, wherein the component part is a bearing, a gear, a motor, or a hydraulic system.
